(19) United States
(12) Patent Application Publication
(10) Pub. No.: US 2006/0231335 A1
(43) Pub. Date: Oct. 19, 2006

(54) Lubrication system for a linear guideway

(75) Inventors: Anita Lin, Taichung (TW); En-Chieh Chen, Taichung (TW)

Correspondence Address: CHARLES E. BAXLEY, ESQ., 90 JOHN STREET, THIRD FLOOR, NEW YORK, NY, 10038, US

(73) Assignee: Hiwin Technologies Corp.

(21) Appl. No.: 11/452,047

(22) Filed: Jun. 13, 2006

Related U.S. Application Data
(63) Continuation-in-part of application No. 10/774,126, filed on Feb. 6, 2004.

(51) Int. Cl. F16C 17/00

(52) U.S. Cl. 184/5

(57) ABSTRACT

A lubrication system for a linear guideway is disposed between an end cap and a capping plate at either side of a sliding block, and comprises: an oil feeding hole, a first oil guiding route, a first oil-flowing hole, a second oil guiding route, a second oil-flowing hole, an upper ball rolling groove and a lower ball rolling groove. The lubrication system for a linear guideway is a three dimensional structure for enabling oil to flow in a 3D manner into the respective ball rolling grooves to lubricate rolling balls more evenly, and the problem of oil leakage can also be prevented.

This application is a continuation of part of U.S. patent application Ser. No. 10/774,126 filed on Feb. 6, 2004, which claims the benefit of the earlier filing date.

### BACKGROUND OF THE INVENTION

1. Field of the Invention

The present invention relates to a lubrication system for a linear guideway, and more particularly to a lubrication system for a linear guideway with a three-dimensional (3D) oil route for enabling oil to flow in a 3D manner into the respective ball rolling grooves to lubricate rolling balls more evenly, and the problem of oil leakage can also be prevented.

2. Description of the Prior Arts

Most of machines are equipped with a linear guiding device, such as a linear guideway, and the rolling balls of the linear guideway should be well lubricated, then the linear guideway can run smoothly and its service life can be prolonged.

Conventionally, most of the linear guideways, as shown in FIG. 10, is formed in its end cap 60 with an oil feeding hole 617, and then an oil route 62 formed in the contacting surface of the end cap 60 cooperates with the end surface of the sliding block to form an oil access. Oil flows along the oil access into the upper ball rolling groove 63 and the lower ball rolling groove 64. Furthermore, for the sake of cost reduction, the contacting surface of the end cap is usually designed in the form a capping plate. The capping plate is defined with a predetermined oil route for introducing the oil into the ball rolling groove of the end cap. According to the two above-mentioned lubricating methods, the oil is unlikely to be evenly distributed to the respective ball rolling grooves since the oil flows in the same level. As a result, the rolling balls in the respective ball rolling grooves are not lubricated equally, and the service life of the rolling balls will be different. Thereby the service life of the linear way will be shortened. Moreover, the oil route is exposed on the contacting surface of the end cap and the sliding block, if a machining error is caused or the contacting surfaces of the end cap and the sliding block are not smooth, the oil will leak from the oil route between the contacting surfaces.

US Pt 2002/0181810 discloses a lubrication system for a linear guideway whose oil grooves are also in the same level, namely, in a two dimensional manner, the oil is distributed from the top down to the respective oil grooves. The disadvantage of this lubrication system is also the same as the abovementioned conventional lubrication system, since the oil grooves are arranged in the same surface from the top down to the bottom, the oil flowing to the lower oil grooves will definitely be fewer than the oil distributed to the upper oil grooves, and thus the oil cannot be distributed evenly.

US Pt 5161896 discloses a lubrication structure for a linear guideway, in which, the oil also can be fed through three oil feeding holes defined the sliding block in three different directions, and an oil collecting hole is defined in the sliding block to transport the oil to the surface of the guideway. Such a lubrication structure is unable to evenly distribute the oil and to solve the problem of oil leakage.

And there is another lubrication structure disclosed in US Pt 2003/0164246, wherein the lubrication structure is provided in the contacting surface between the sliding block 61 and the sealing member 66, and an oil guiding member 72 is disposed in the oil groove 71 for guiding the oil to the rollers, thus achieving a lubricating effect. However, this lubrication structure is not an enclosed space, and there is a clearance in the contacting surface between the sliding block 61 and the sealing member 66. Therefore, the oil is likely to leak from the clearance, and as a result, the sealing effect is not ideal.

The present invention has arisen to mitigate and/or obviate the afore-described disadvantages of the conventional lubrication system of linear guideway.

### SUMMARY OF THE INVENTION

The primary object of the present invention is to provide a lubrication system for a linear guideway, which is capable of averagely distributing lubricating oil to the respective ball rolling grooves to lubricate the rollers evenly.

The secondary object of the present invention is to provide a lubrication system for a linear guideway, which is capable of improving sealing effect of the oil route.

The present invention provides a new solution to solve the uneven distribution of oil of the conventional lubrication system of linear guideway, so that the lubrication system in accordance with the present invention has an ability of distributing the oil averagely.

The present invention re-design an oil route by using the end cap and the capping plate of the linear guideway. The conventional two-dimensional (2D) oil lubricating structure has been revised to the three-dimensional (3D) oil lubricating structure. The 3D spatial oil distributing structure is formed between the end cap and the capping plate, so that oil can flow in a 3D manner to a middle portion between the upper and lower ball rolling grooves, and then the oil is distributed averagely to the respective ball rolling grooves to lubricate the rollers. Furthermore, since the oil lubricating structure of the present invention is formed in 3D manner, and the lubricating structure is defined on the contacting surface between of the end cap and the capping plate and not on the contacting surfaces of the end cap and of the sliding block, therefore the problem of the oil leakage from the contacting surface of the end cap and of the sliding block can be overcome.

On the other hand, the capping plate of the present invention is additionally provided with a special stopping piece that is used to improve the sealing effect. The stopping structure is disposed in the oil feeding hole in the contacting surfaces of the end cap and of the sliding block, so as to prevent the oil leakage from the contacting surface of the end cap and of the sliding block, such that the sealing effect is improved. In addition, the stopping structure is a detachable structure that allows the oil to be fed in three different directions, so as to improve its applicability.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is an exploded view of a lubrication system of linear guideway in accordance with the present invention;

FIG. 2 is a perspective view of an end cap in FIG. 1;

FIG. 3 is a front view of the capping plate of FIG. 1;

FIG. 4 is a rear view of the capping plate of FIG. 1;

FIG. 5 is an assembly view of the end cap and the capping plate in accordance with the present invention;

FIG. 6 is a cross sectional view of the assembly of the end cap and the capping plate in FIG. 5;

FIG. 7 is a perspective view of a lubrication system with oil feeding holes formed at different sides thereof in accordance with the present invention;

FIG. 8 is a partial cross sectional view of FIG. 7;

FIG. 9 is an illustrative view of the stopping piece of the capping plate of the lubrication system in accordance with the present invention;

FIG. 10 is a cross sectional view of an end cap of conventional lubrication system of linear guideway.

### DETAILED DESCRIPTION OF THE PREFERRED EMBODIMENT

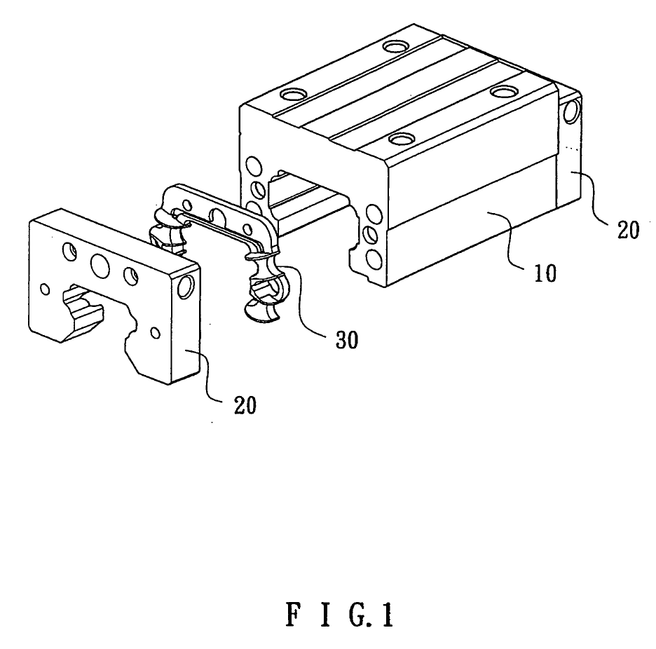

FIG. 1 is an exploded view of a lubrication system of a linear guideway in accordance with the present invention, wherein an end cap 20 and a capping plate 30 are provided at both ends of a sliding block 10. The end cap 20 and the capping plate 30 cooperate with each other to form a complete ball rolling groove for allowing for circulation of the rolling balls.

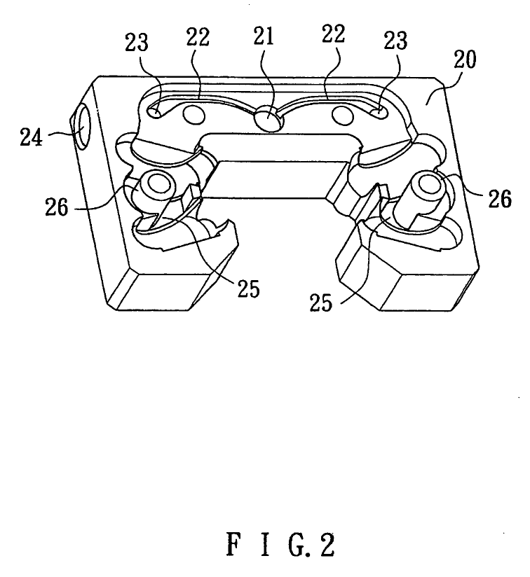

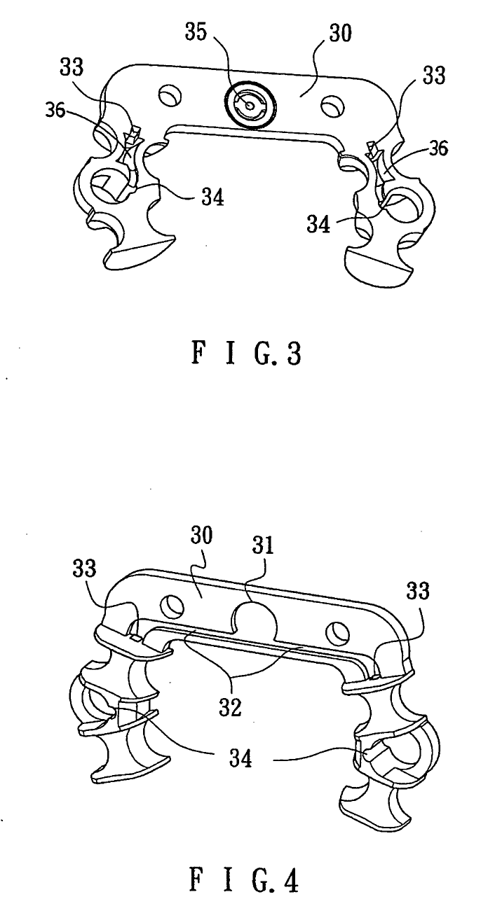

FIG. 2 is a perspective view of the end cap in FIG. 1. FIG. 3 is a front view of the end cap in FIG. 1. FIG. 4 is a rear view of the end cap in FIG. 1. The end cap 20 has two oil feeding holes 21 and 24 defined in its end surface and side surface respectively. When the oil is injected into oil-flowing hole 31 of the capping plate 30 via the oil feeding hole 21, since a stopping piece 35 stops the flow of the oil into the end surface of the sliding block, the oil will be introduced to a first oil-flowing hole 33 at both sides of the capping plate 30 by a first oil guiding route 32. And then the oil will flow along a second oil guiding route 36 to a second oil-flowing hole 34 in the front surface (contacting the sliding block) of the capping plate 30 from the rear surface (contacting the end cap 20) thereof. After that, the second oil-flowing hole 34 formed in the capping plate 30 and located at a mid position between the upper and lower ball rolling grooves (approximately at the position of threaded hole 26) will guide the oil back to the rear surface of the capping plate 30 and to the curved surface 25 of the end cap 20. And thus, the oil can be supplied to the upper and the lower ball rolling grooves for lubricating the rolling balls properly. Furthermore, if it is injected into the oil feeding hole 24, the oil will flow into the oil feeding hole 21 via the oil-flowing hole 23 and an oil guiding route 22, and then flow into the upper and the lower ball rolling grooves also through the abovementioned path.

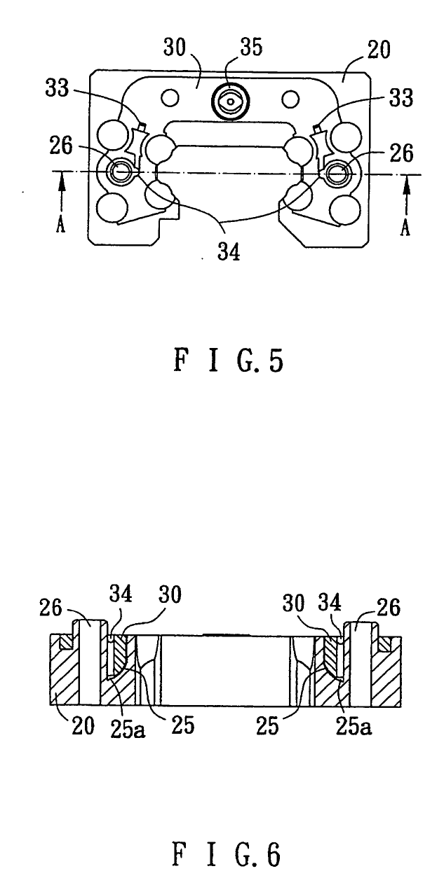

FIG. 5 is an assembly view of the end cap and the capping plate in accordance with the present invention. FIG. 6 is a cross sectional view of the assembly of the end cap and the capping plate of FIG. 5. When the oil is poured in the end cap 20 and introduced into the second oil-flowing hole 34 beside the threaded hole 26 via the first oil-flowing hole 33 of the capping plate 30. The capping plate 30 cooperates with the curved surface 25 of the end cap 20 to form a feed hole 25a, so that the oil flows into the feed hole 25a via the second oil-flowing hole 34. Since the feed hole 25a is very small, the oil is distributed to the upper and the lower ball rolling groove by capillary action.

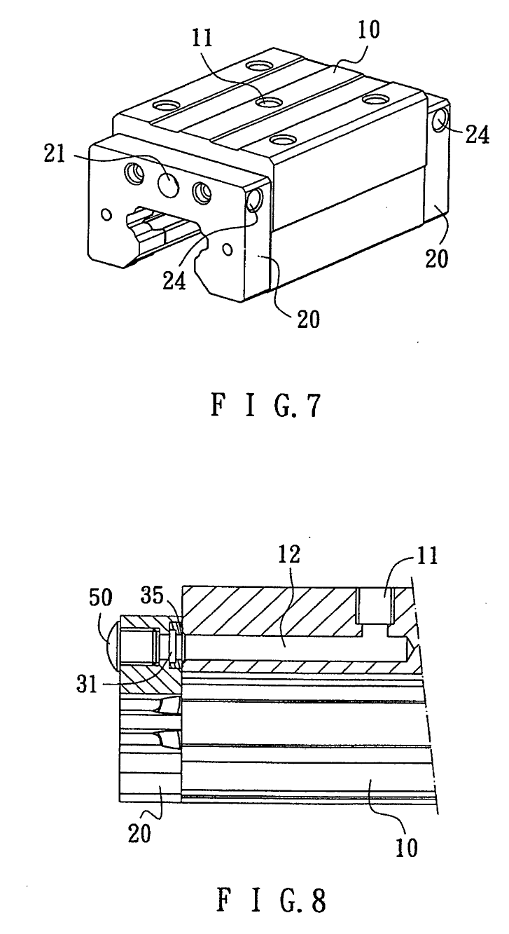

FIG. 7 is a perspective view in accordance with the present invention of showing a lubrication system with three oil feeding holes formed in three different directions thereof. FIG. 8 is a cross sectional view of a part of FIG. 7. Oil can also be injected into the oil feeding hole 11 in the top surface of the sliding block 10 besides being fed into the oil feeding holes 21 and 24. When the oil is fed into the access 12 via the oil feeding hole 11 and flows through the already open stopping piece 35 into the oil-flowing hole 31 and the oil feeding hole 21 respectively. At this moment, a screw 50 is screwed in the oil feeding hole 21 to close the oil feeding hole 21. Therefore, the oil will flow along the first oil guiding route 32 to the feed hole 25a via the above-mentioned path, so as to lubricate the rolling balls in the upper and the lower ball rolling grooves.

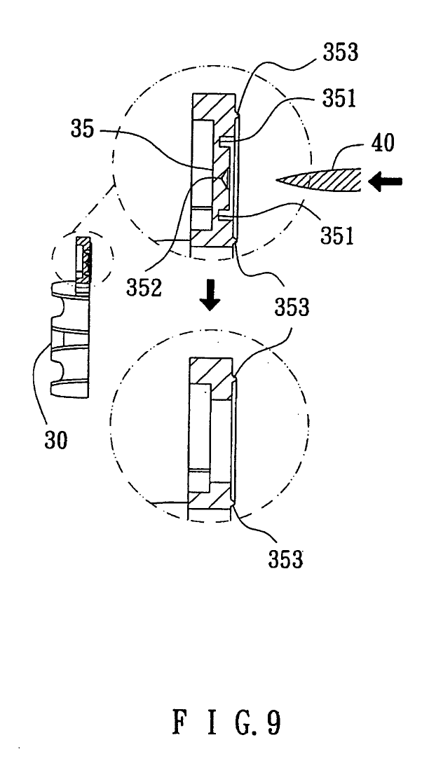

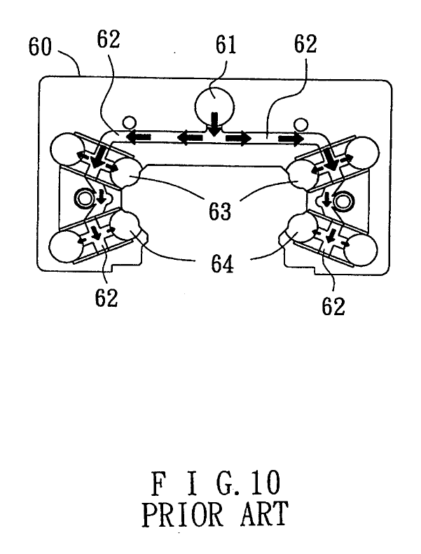

FIG. 9 is an illustrative view of the stopping piece of the capping plate of the lubrication system in accordance with the present invention, wherein the stopping piece 35 of the capping plate 30 is installed in the oil-flowing hole 31 (on the contacting surface for contacting the sliding block). The stopping piece 35 includes: annular groove 351, cone-shaped recess 352 and annular protrusions 353. Since the thickness of the stopping piece 35 at the position of the annular groove 351 is reduced and the hardness of the portion in the annular groove 351 is thin and becomes weak, it is easy for the user to separate the portion surrounded by the annular groove 351 from the capping plate 30 just by pushing the cone-shaped recess 352 with a cone-shaped tool 40, so as to produce an access on the stopping piece 35, namely, the stopping piece 35 is open. Furthermore, in order to improve the sealing effect in the direction of the oil feeding hole 11, an annular flange 353 is defined at the outer periphery of the oil feeding hole 11 for prevention of oil leakage therefrom.

To summarize, the present invention has the following advantages:

First of all, the lubrication system of linear guideway in accordance with the present invention has changed the oil route structure from conventional two-dimensional (2D) structure into 3D structure, thus allowing the oil to flow through a three dimensional space to the middle portion between the upper and the lower ball rolling grooves, and thus the oil can be evenly distributed to the respective ball rolling grooves to lubricate the rolling balls.

Second of all, the lubrication system of linear guideway of the present invention is formed in a three dimensional manner, namely, the lubricating structure is defined on the contacting surfaces of (between the end cap and the capping plate) the end cap and the capping plate, but is not on the cooperating surface between the end cap and the sliding block, thus preventing oil leakage from the cooperating surface between the end cap and the sliding block.

Finally, to improve the sealing effect during oil injection, the capping plate of the present invention is additionally provided with a stopping piece that is used to prevent oil leakage. And to enable the oil to be fed in three directions, the stopping piece is designed to be detachable, so as to improve its applicability.

While we have shown and described various embodiments in accordance with the present invention, it should be clear to those skilled in the art that further embodiments may be made without departing from the scope of the present invention.

What is claimed is:

1. A lubrication system for a linear guideway disposed between an end cap and a capping plate at either side of a sliding block, comprising: an oil feeding hole, a first oil guiding route, a first oil-flowing hole, a second oil guiding route, a second oil-flowing hole, an upper ball rolling groove and a lower ball rolling groove:
wherein the oil feeding hole is connected to the first oil guiding route, the first oil guiding route is formed by the end cap and the capping plate, the second oil guiding route is formed in a rear surface of the capping plate opposite the first oil guiding route, the first oil-flowing hole is employed to connect the first oil guiding route and the second oil guiding route, the upper and lower ball rolling grooves are defined in the lubrication system respectively, the second oil-flowing hole is connected to the second oil guiding route and is located between the upper and lower ball rolling grooves, for allowing the second oil-flowing hole to be connected both to the upper ball rolling groove and the lower ball rolling groove synchronously, by such arrangements, oil fed into the oil feeding hole, after flowing to the second oil-flowing hole through the first oil guiding route, the first oil-flowing hole and the second oil guiding route, will be evenly distributed to the upper ball rolling groove and the lower ball rolling groove to lubricate rollers.

2. The lubrication system for a linear guideway as claimed in claim 1, wherein the capping plate is provided with stopping piece, so as to prevent oil leakage from the contacting surfaces of the end cap and the sliding block.

3. The lubrication system for a linear guideway as claimed in claim 2, wherein the stopping piece is a detachable structure.
